(19) United States
(12) Patent Application Publication
(10) Pub. No.: US 2012/0255669 A1
(43) Pub. Date: Oct. 11, 2012

(54) METHOD FOR MANUFACTURING LARGE MOLDED MONOLITHIC PRODUCTS

(76) Inventors: Philip Catsman, Tequesta, FL (US); Wayne Lukey, Port St. Lucie, FL (US); Zackary N. Bausch, Stuart, FL (US)

(21) Appl. No.: 13/083,702

(22) Filed: Apr. 11, 2011

(51) Int. Cl. B32B 37/02; B32B 38/00; B29C 53/56

(52) U.S. Cl. 156/189

(57) ABSTRACT

The present invention provides a process for making monolithic fiber composite parts comprising the steps of providing a first mold part having a first inner surface and a second mold part having a second inner surface. Applying a gel coat to the first inner surface and to the second inner surface and then curing the gel coat. Placing a fiber reinforcement fabric onto the gel coat. Placing a removable mandrel, shear web components and a partially inflated bladder bag onto the fiber reinforcement fabric. Wrapping the fiber reinforcement fabric over the mandrel, the shear web components and the bladder bag. Sealing the second mold part to the first mold part to form a closed mold and fully inflating the bladder bag. Providing a vacuum feed and a resin feed onto the closed mold. Applying vacuum to the closed mold through the vacuum feed and removing the mandrel. Infusing resin into the vacuum closed mold through the resin feed to form a part. Curing and hardening the part. Unsealing the second mold part from the first mold part and removing the part.

### FIELD OF THE INVENTION

The present invention relates to a process for the production of composite molded articles. More specifically, the invention relates to the manufacturing of large composite monolithic products.

### BACKGROUND OF THE INVENTION

The manufacturing of large molded objects, such as boat hulls, large blades for an electricity-generating wind farm windmill, and the like, is problematic. Such large objects are typically molded by a time-consuming manual process. This drives up the cost of the individual products. Items made by manual labor are also more likely to be of inconsistent quality as no two products will be exactly alike.

An example of a large object that is typically molded by a time-consuming manual process is a wind turbine which is a machine for converting the kinetic energy in wind into mechanical energy. If that mechanical energy is used directly by machinery, such as to pump water or to grind wheat, then the wind turbine may be referred to as a windmill. Similarly, if the mechanical energy is further transformed into electrical energy, then the turbine may be referred to as a wind generator or wind power plant.

The blades for modern wind generators can be over eighty meters long. Therefore, in order to minimize weight and maximize strength, the blades are often formed as fiber-reinforced plastic shells in which a fiber material, such as fiberglass, carbon, or aramid is used to reinforce a polymer matrix, such as epoxy, vinylester or polyester thermosetting plastic resin. A hand lay-up technique is most-often used to apply the fabric components against a one-sided mold, after which resin is forced through the individual fiber mats using hand rollers. Once the fabric is saturated with resin, then the excess resin is removed with squeegees and the part is allowed to cure. Variations on this method include individually saturating each fiber mat before it is applied to the mold through the use of “pre-preg” material, and/or using applicators that saturate each layer before it is added to the mold.

What is needed, then, is a new manufacturing process for making large molded monolithic products. More particularly, there is a need for a manufacturing process that reduces the amount of manual labor needed to produce such objects. The needed process would reduce the cost of such objects. There is also a need for a new process that provides products having consistently high quality.

Nothing in the prior art provides the benefits attendant with the present invention.

Another object of the present invention is to provide a process for making monolithic fiber composite parts comprising the steps of providing a first mold part having a first inner surface; providing a second mold part having a second inner surface; applying a gel coat to said first inner surface of said first mold part and to said second inner surface of said second mold part; curing said gel coat; placing a fiber reinforcement fabric onto said gel coat; placing a removable mandrel onto said fiber reinforcement fabric; placing shear web components onto said fiber reinforcement fabric; placing a bladder bag onto said fiber reinforcement fabric, said bladder bag being partially inflated; wrapping said fiber reinforcement fabric over said mandrel, said shear web components and said partially inflated bladder bag; sealing said second mold part to said first mold part to form a closed mold; fully inflating said bladder bag; providing a vacuum feed onto said closed mold; providing a resin feed onto said closed mold; applying vacuum to said closed mold through said vacuum feed; removing said mandrel; infusing resin into said vacuum closed mold through said resin feed to form a part; curing and hardening said part; unsealing said second mold part from said first mold part; and removing said part.

Yet another object of the present invention is to provide a process for making a monolithic fiber composite wind blade comprising the steps of providing a mold plug; developing a first mold part having a first inner surface and a second mold part having a second inner surface from said mold plug; applying a gel coat to said first inner surface of said first mold part and to said second inner surface of said second mold part; curing said gel coat; placing a fiber reinforcement fabric onto said gel coat; placing a removable mandrel onto said fiber reinforcement fabric; placing shear web components onto said fiber reinforcement fabric; placing a bladder bag onto said fiber reinforcement fabric, said bladder bag being partially inflated; wrapping said fiber reinforcement fabric over said mandrel, said shear web components and said bladder bag; sealing said second mold part to said first mold part to form a closed mold; fully inflating said bladder bag; providing a vacuum feed onto said closed mold; providing a resin feed onto said closed mold; applying vacuum to said closed mold through said vacuum feed; removing said mandrel; infusing resin into said vacuum closed mold through said resin feed to form the wind blade; curing and hardening said wind blade; unsealing said second mold part from said first mold part; and removing said wind blade.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The long-standing but heretofore unfulfilled need for an improved manufacturing process for making large molded objects is now met by a new, non-obvious, and useful invention. Briefly, and in accordance with the foregoing, the present invention provides the ability to manufacture changing shape, hollow profile parts in a single step; the ability to bridge across two molded parts without cutting or overlapping reinforcing fabrics over a previously cured surface thereby increasing strengths, reducing weight, labor and material costs; the use of permanent and/or removable composite, wood, foam or metal mandrels to assure symmetry of reinforcements and inner and outer shape of the part and the use of permanent and/or removable composite or metal mandrels/structural elements to assure proper location of attachment hardware.

A process for making monolithic fiber composite parts with hollow sections is described. The part is manufactured using a two, three or four part rigid outer mold, the geometry of the mold dissects the part along the leading and trailing edges allowing layup on the high and low pressure side of the airfoil specifically, with a rigid, removable mandrel along with semi rigid or soft bladder bag(s). The mold is opened and release agents, gel coat, and fiberglass reinforcement fabrics are applied. The rigid, removable mandrel(s) are then tightly wrapped in fiberglass fabric, placed into the mold along with the bladder bags, and internal load bearing structural elements herein referred to as the “shear web”, the mold is closed, bladder bag(s) fully inflated, vacuum, and resin feed tubes are applied.

A feature of the present invention is to provide a process for making monolithic fiber composite parts comprising the steps of providing a first mold part having a first inner surface and a second mold part having a second inner surface. Applying a gel coat to the first inner surface and to the second inner surface and then curing the gel coat. Placing a fiber reinforcement fabric onto the gel coat. Placing a removable mandrel, shear web components and a partially inflated bladder bag onto the fiber reinforcement fabric. Wrapping the fiber reinforcement fabric over the mandrel, the shear web components and the bladder bag. The fiber reinforcement fabric can be joined in an interlocking manner. Sealing the second mold part to the first mold part to form a closed mold and fully inflating the bladder bag. Alternatively, a cap can be provided wherein the cap seals the second mold part to the first mold part to form a closed mold. Providing a vacuum feed and a resin feed onto the closed mold. Applying vacuum to the closed mold through the vacuum feed and removing the mandrel. Infusing resin into the vacuum closed mold through the resin feed to form a part. Curing and hardening the part. Unsealing the second mold part from the first mold part and removing the part.

Another feature of the present invention is to provide a process for making a monolithic fiber composite wind blade comprising the steps of providing a mold plug and developing a first mold part having a first inner surface and a second mold part having a second inner surface from said mold plug. Applying a gel coat to the first inner surface and to the second inner surface of the second mold part and then curing the gel coat. Placing a fiber reinforcement fabric onto the gel coat. Placing a removable mandrel, shear web components and a partially inflated bladder bag onto the fiber reinforcement fabric. Wrapping the fiber reinforcement fabric over the mandrel, the shear web components and the bladder bag. The fiber reinforcement fabric can be joined in an interlocking manner. Sealing the second mold part to the first mold part to form a closed mold and fully inflating the bladder bag. Alternatively, a cap can be provided wherein the cap seals the second mold part to the first mold part to form a closed mold. Providing a vacuum feed and a resin feed onto the closed mold. Applying vacuum to the closed mold through the vacuum feed and removing the mandrel. Infusing resin into the vacuum closed mold through the resin feed to form the wind blade. Curing and hardening the wind blade. Unsealing the second mold part from the first mold part and removing the wind blade.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a perspective view of a mold plug according to the present invention;

FIG. 2 is a perspective view of a multi-part hinged mold according to an embodiment of the present invention;

FIG. 3 is a perspective view of a multi-part hinged mold with a fiber reinforcement according to an embodiment of the present invention;

FIG. 4 is a perspective view of a multi-part hinged mold with a fiber reinforcement and a mandrel according to an embodiment of the present invention;

FIG. 5 is a perspective view of an open multi-part hinged mold with a fiber reinforcement, a mandrel and a shear web according to an embodiment of the present invention;

FIG. 6 is a perspective view of an open multi-part hinged mold with a fiber reinforcement, a mandrel and a shear web according to an embodiment of the present invention;

FIG. 7 is a perspective view of a closed multi-part hinged mold with a fiber reinforcement, a mandrel and a shear web according to an embodiment of the present invention; and

FIG. 8 is a perspective view of a closed multi-part hinged mold with a resin feeds and vacuum feeds according to an embodiment of the present invention.

Similar reference characters refer to similar parts throughout the several views of the drawings.

### DETAILED DESCRIPTION OF THE INVENTION

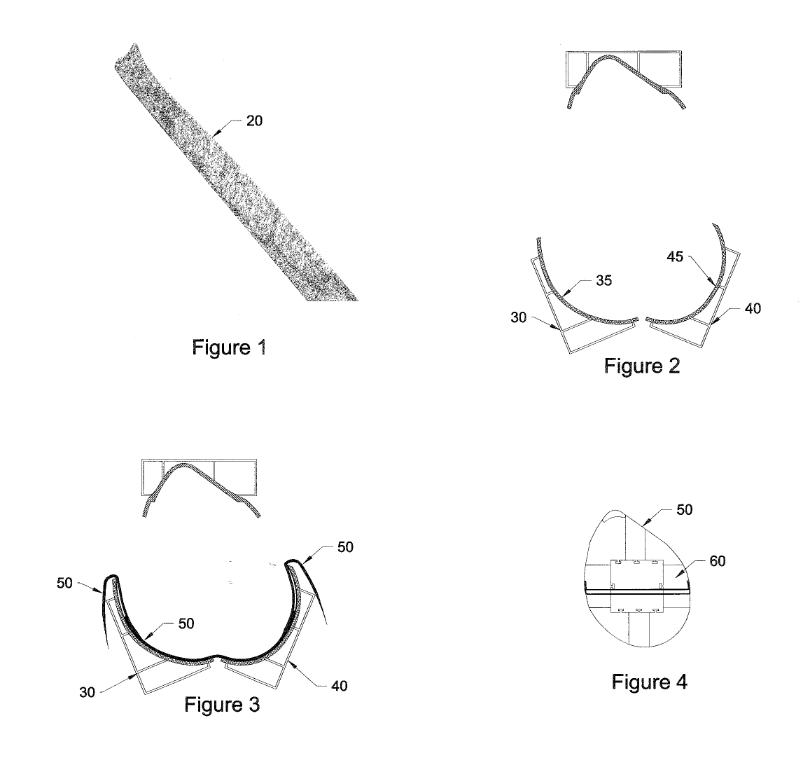

The present invention provides a method that can be used for making monolithic fiber composite parts which includes a hollow monolithic fiber composite wind blade. Using a form plug 20 as shown in FIG. 1, a multi-part mold as shown in FIG. 2 is developed. The multi-part mold comprises two primary mold parts, a first mold part 30 having a first inner surface 35 and a second mold part 40 having a second inner surface 45. The first mold part 30 can be hinged or otherwise connected to the second mold part 40. With the two primary mold parts 30, 40 of the mold separated and open, a gel coat, a release agent or other polymeric coatings are applied to the mold surfaces 35, 45.

After the gel coat is properly cured, the two primary mold parts 30, 40 are left open for placement of a fiber reinforcement fabric 50 as shown in FIG. 3. The fiber reinforcement fabric 50 runs along the full length on the outer mold surface of the first mold part 30 allowing the fiber reinforcement fabric to extend far enough beyond the leading or trailing edge.

As shown in FIG. 4, the fabric reinforcement fabrics overlaps on each side of a removable mandrel 60 and/or bladder bag(s). This fabric extension considers the possible need for future additional reinforcements and other internal components. The material for the removable mandrel is selected from the group consisting of a fiber composite, foamed polymer, wood, wood composite, ceramic and metal. The removable mandrel can provide the proper location of attachment hardware to the part to be molded.

The mandrel 60 is wrapped with the fiber reinforcing fabric 50 as shown in FIG. 4. The fiber reinforcement fabric can be wrapped continuously over the mandrel. As shown in FIG. 5, the mandrel 60 is then loaded into the open two primary mold parts 30, 40 along with the shear web components 70 and bladder bag(s). The mandrel can be placed symmetrically within the first mold part and the second mold part. The bladder bag(s) are partially inflated. The fiber reinforcing fabric 50 extends onto the outer surface of the primary mold parts 30, 40.

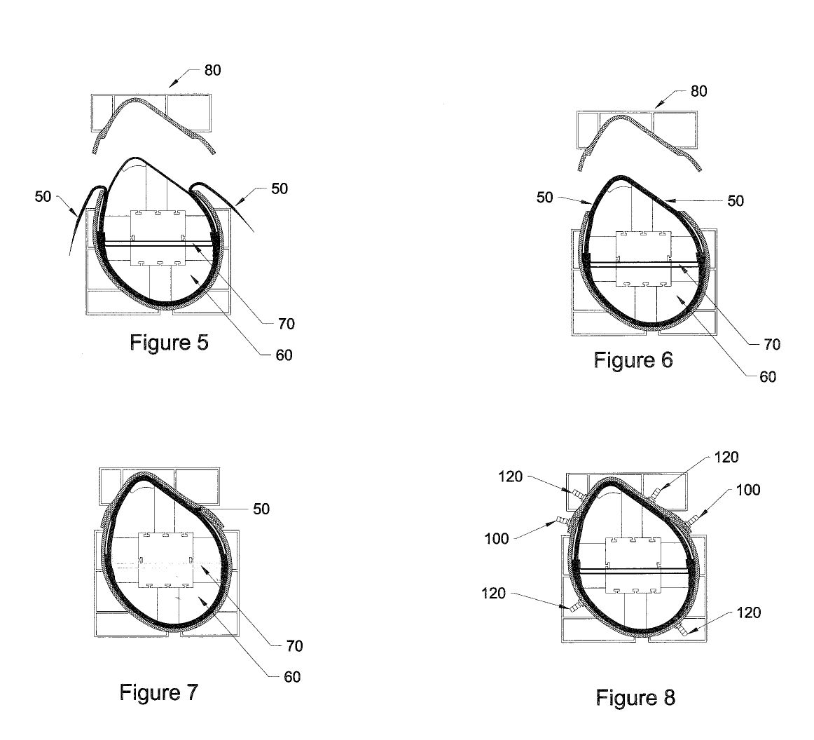

As shown in FIG. 6, the fiber reinforcing fabric 50 is wrapped over the mandrel 60, the shear web components 70 and the bladder bag(s). The fiber reinforcing fabric can then be joined in an interlocking manner completing the monolithic geometry between the high and low pressure sides of the part.

The mold is closed by joining the first mold part to the second mold part. The hinge is placed in a manner to create equal pressure around the fiber reinforcing fabric 50, the mandrel 60, the shear web components 70 and the bladder bag. In an alternative embodiment, a cap 80 (as shown in FIG. 7) can be provided, wherein the cap 80 seals the second mold part to the first mold part to form a closed mold. The mold is sealed and the bladder bag(s) is fully inflated. Vacuum feed tubes 100 and resin feed tubes 120 are applied to the mold as shown in FIG. 8. Vacuum is applied to the mold through the vacuum feed tubes 100. The removable mandrel 60 is removed from the mold cavity. Resin is infused through the resin feed tubes 120 to form a part such as a hollow monolithic wind blade. The part (wind blade) is allowed to cure and harden. After the part (wind blade) has cured fully it is removed from the mold and the mold is prepared for another part (wind blade).

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A process for making monolithic fiber composite parts comprising the steps of:
providing a first mold part having a first inner surface;
providing a second mold part having a second inner surface;
applying a gel coat to said first inner surface of said first mold part and to said second inner surface of said second mold part;
curing said gel coat;
placing a fiber reinforcement fabric onto said gel coat;
placing a removable mandrel onto said fiber reinforcement fabric;
placing shear web components onto said fiber reinforcement fabric;
placing a bladder bag onto said fiber reinforcement fabric, said bladder bag being partially inflated;
wrapping said fiber reinforcement fabric over said mandrel, said shear web components and said partially inflated bladder bag;
sealing said second mold part to said first mold part to form a closed mold;
fully inflating said bladder bag;
providing a vacuum feed onto said closed mold;
providing a resin feed onto said closed mold;
applying vacuum to said closed mold through said vacuum feed;
removing said mandrel;
infusing resin into said vacuum closed mold through said resin feed to form a part;
curing and hardening said part;
unsealing said second mold part from said first mold part; and
removing said part.

2. The process for making monolithic fiber composite parts according claim 1, further comprising providing a cap, said cap sealing said second mold part to said first mold part to form a closed mold.

3. The process for making monolithic fiber composite parts according claim 1, further comprising joining said fiber reinforcement fabric in an interlocking manner.

4. The process for making monolithic fiber composite parts according claim 1, wherein said first mold part is connected to said second mold part.

5. The process for making monolithic fiber composite parts according claim 1, wherein said first mold part is hinged to said second mold part.

6. The process for making monolithic fiber composite parts according claim 1, further comprising applying a release agent to said first inner surface of said first mold part and to said second inner surface of said second mold part.

7. The process for making monolithic fiber composite parts according claim 1, wherein said removable mandrel is selected from the group consisting of a fiber composite, foamed polymer, wood, wood composite, ceramic and metal.

8. The process for making monolithic fiber composite parts according claim 1, wherein said removable mandrel provides the proper location of attachment hardware.

9. The process for making monolithic fiber composite parts according claim 1, wherein said fiber reinforcement fabric is wrapped continuously over said mandrel.

10. The process for making monolithic fiber composite parts according claim 1, wherein said mandrel is placed symmetrically within said first mold part and said second mold part.

11. A process for making a hollow monolithic fiber composite wind blade comprising the steps of:
providing a mold plug;
developing a first mold part having a first inner surface and a second mold part having a second inner surface from said mold plug;
applying a gel coat to said first inner surface of said first mold part and to said second inner surface of said second mold part;
curing said gel coat;
placing a fiber reinforcement fabric onto said gel coat;
placing a removable mandrel onto said fiber reinforcement fabric;
placing shear web components onto said fiber reinforcement fabric;
placing a bladder bag onto said fiber reinforcement fabric, said bladder bag being partially inflated;
wrapping said fiber reinforcement fabric over said mandrel, said shear web components and said bladder bag;
sealing said second mold part to said first mold part to form a closed mold;
fully inflating said bladder bag;
providing a vacuum feed onto said closed mold;
providing a resin feed onto said closed mold;
applying vacuum to said closed mold through said vacuum feed;
removing said mandrel;
infusing resin into said vacuum closed mold through said resin feed to form the wind blade;
curing and hardening said wind blade;
unsealing said second mold part from said first mold part; and
removing said wind blade.

12. The process for making a hollow monolithic fiber composite wind blade according claim 11, further comprising providing a cap, said cap sealing said second mold part to said first mold part to form a closed mold.

13. The process for making a hollow monolithic fiber composite wind blade according claim 11, further comprising joining said fiber reinforcement fabric in an interlocking manner.

14. The process for making a hollow monolithic fiber composite wind blade according claim 11, wherein said first mold part is connected to said second mold part.

15. The process for making a hollow monolithic fiber composite wind blade according claim 11, wherein said first mold part is hinged to said second mold part.

16. The process for making a hollow monolithic fiber composite wind blade according claim 11, further comprising applying a release agent to said first inner surface of said first mold part and to said second inner surface of said second mold part.

17. The process for making a hollow monolithic fiber composite wind blade according claim 11, wherein said removable mandrel is selected from the group consisting of a fiber composite, foamed polymer, wood, wood composite, ceramic and metal.

18. The process for making a hollow monolithic fiber composite wind blade according claim 11, wherein said removable mandrel provides the proper location of attachment hardware.

19. The process for making a hollow monolithic fiber composite wind blade according claim 11, wherein said fiber reinforcement fabric is wrapped continuously over said mandrel.

20. The process for making a hollow monolithic fiber composite wind blade according claim 11, wherein said mandrel is placed symmetrically within said first mold part and said second mold part.
